(19) United States
(12) Patent Application Publication
(10) Pub. No.: US 2025/0010717 A1
(43) Pub. Date: Jan. 9, 2025

(54) METHOD FOR OPERATING A LIGHT-BASED DRIVER ASSISTANCE SYSTEM OF A MOTOR VEHICLE

(71) Applicant: Hella GmbH & Co. KGaA, Lippstadt (DE)

(72) Inventors: Boris Kubitza, Möhnesee-Körbecke (DE); Carsten Wilks, Lippstadt (DE)

(21) Appl. No.: 18/897,224

(22) Filed: Sep. 26, 2024

Related U.S. Application Data
(63) Continuation of application No. PCT/EP2023/056712, filed on Mar. 16, 2023.

(30) Foreign Application Priority Data
Mar. 31, 2022 (DE) 102022107700.4

(51) Int. Cl. B60K 35/21

(52) U.S. Cl. CPC B60K 35/211; B60K 2360/334

(57) ABSTRACT

A method is provided for operating a light-based driver assistance system in a motor vehicle. The driver assistance system projects a light distribution onto the road surface in front of the motor vehicle. The light distribution generates lane markings. The lane markings are two individual parallel lane markings at a distance (D) to one another that corresponds to the width of the motor vehicle. The individual lane markings do not look like a solid line.

### CROSS REFERENCE

This application claims priority to PCT Application No. PCT/EP2023/056712, filed Mar. 16, 2023, which itself claims priority to German Application No. 10 2022 107700.4, filed Mar. 31, 2022, the entireties of both of which are hereby incorporated by reference.

### FIELD OF THE INVENTION

The present invention relates to a method for operating a light-based driver assistance system in a motor vehicle in which the driver assistance system projects a light distribution onto the road surface in front of the motor vehicle that generates a light distribution comprising two individual lane markings at a distance to one another that basically corresponds to the width of the motor vehicle.

### BACKGROUND OF THE INVENTION

Light-based driver assistance systems are used to help a driver deal with different driving situations with symbols, signals, or markings projected onto the road surface. By way of example, M. Budanow's publication, Development of a Light-Based Driver Assistance System, KIT Scientific Publishing (2020), discloses tests regarding the effectiveness of light-based driver assistance systems with regard to driving safety and practicality.

A marking corresponding to the width of the vehicle is projected in the form of the lane markings addressed by the present invention onto the road surface in front of the vehicle such that the driver can visualize the available space when entering a construction zone on a highway, for example. In the prior art, these lane markings are two individual lane markings that are spaced apart from one another formed by solid lines, i.e. homogenous strips of light in front of the vehicle that are parallel to one another, forming two boundaries for the presumed lane in front of the vehicle. This type of lighting function is known as “guiding lines” or “optical lane assist.” The individual lane markings are normally 10 centimeters wide, and extend ten or more meters in front of the vehicle.

A disadvantage with these lane markings is that they are detected by cameras integrated in the vehicle, and can be inaccurately interpreted as road surface lane lines, i.e. the lines on the side or in the middle of the road surface. This inaccuracy can result in undesired impacts on the functionality of other driver assistance systems, in particular lane keeping and lane changing assists.

FIG. 1 shows a schematic illustration of how a light-based driver assistance system works with a method from the prior art. The driver assistance system in the motor vehicle 1 projects the light distribution 30a onto the road surface 2, generating the lane markings 3a. The lane markings 3a comprise two individual lane markings 31a, 32a, each of which are a solid line at a distance D to one another corresponding to the width of the motor vehicle 1. Because the individual lane markings 31, 32a are similar to the lane markings 41, 42 bordering the road surface 2, there is a risk that these may be mistaken for one another in an automated evaluation of images obtained with cameras in the vehicle.

### BRIEF SUMMARY OF THE INVENTION

The object of the present invention is to therefore propose an alternative method for operating a light-based driver assistance system that overcomes the aforementioned disadvantages of the prior art.

The invention includes the technical instruction that the individual lane markings are not solid lines.

The invention is based on the idea that the lane markings should be difficult for an image evaluation algorithm to mistake for road surface markings. For this reason, the individual lane markings generated by the light distribution projected onto the road surface should look different than the individual lines from the prior art. A solid line can still be part of an individual lane marking in the framework of the method obtained with the invention, but must be supplemented with other components to obtain a marking pattern that basically cannot be mistaken for the lane markings on the road surface by an automated evaluation of images obtained with cameras in the vehicle when it is travelling.

In particular, it is proposed that the individual lane markings have a different appearance than the normal road surface lane markings. These normal road surface lane markings are understood to be the official markings used to indicate traffic lanes along a road surface. The regulations regarding these road surface lane markings for Germany can be found in the Straßenverkehrsordnung (StVO; EN: road traffic regulations), in which identical or similar markings to those used worldwide are shown. In Germany, a solid line indicates the boundary of a road surface, a broken line indicates a dividing line, a solid line combined with a broken line is a lane boundary, and a double line separates two traffic lanes.

For this reason, individual lane markings should not have the same appearance as a double line, a broken line, or a pair of lines, one of which is broken, while the other is continuous. The overall design of the individual lane markings can nevertheless contain these types of lines as well as other components to obtain a more complex pattern.

In an advantageous embodiment, the lane markings generated by the projected light distribution comprises two individual lane markings, each of which contains at least three parallel lines, preferably three to five parallel lines, particularly preferably four parallel lines. These individual lane markings are formed by groups of parallel stripes, the widths and spacings of which are to be selected such that the stripes can be seen as individual entities in an image evaluation obtained within the vehicle. By way of example, each of the three parallel lines can be of different widths.

In another embodiment, the individual lane markings can contain a pattern of separate polygonal elements, e.g. a herringbone pattern. The individual lane markings can also contain a pattern made of separate freeform elements. In particular, these elements are projected onto the road surface in a row, spaced apart from one another.

With the method according to the invention, the lane markings can be generated directly in the light distribution projected onto the road surface, i.e. the lane markings can be formed by the section of the road surface lit by the driver assistance system. This embodiment is particularly ideal during the daytime.

Alternatively, the lane markings obtained with the invention can be generated by unlit sections within the light distribution projected onto the road surface, i.e. the lane markings can be unlit sections of the otherwise lit road surface. This is particularly ideal at nighttime, when the road surface in front of the vehicle is lit by the low beam light distribution.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a method from the prior art.

FIG. 2 shows a first exemplary embodiment of the method obtained with the invention.

FIG. 3 shows a second exemplary embodiment.

FIG. 4 shows a third exemplary embodiment.

FIG. 5 shows a fourth exemplary embodiment.

FIG. 6 shows a fifth exemplary embodiment.

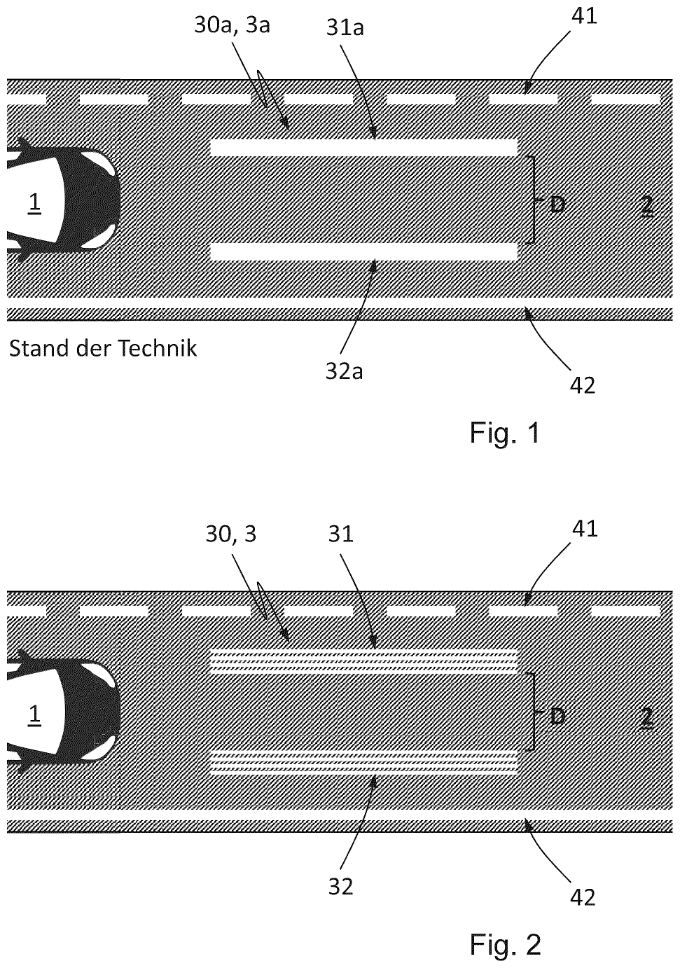

### DETAILED DESCRIPTION OF THE DRAWINGS

FIGS. 2-6 show schematic illustrations of different exemplary embodiments of the method obtained with the invention for operating a light-based driver assistance system in a motor vehicle 1. The light distribution 30 is projected by the driver assistance system onto the road surface 2 in front of the motor vehicle 1, generating the lane markings 3 comprising two parallel individual lane markings 31, 32 at a distance D to one another substantially corresponding to the width of the motor vehicle 1. The width of the lane markings 2 substantially corresponds to the overall width of the motor vehicle 1, including the side-view mirrors.

These individual lane markings 31, 32 differ from a solid line, in particular the lines used for normal road surface lane markings. The individual lane markings 31, 32 obtained with the invention are significantly different than lane markings or boundaries used for road surface lane markings 41, 42, such that they cannot be mistaken for such in an automated image evaluation of recordings obtained with a camera in the vehicle, or are at least much more difficult to do so than with the methods from the prior art.

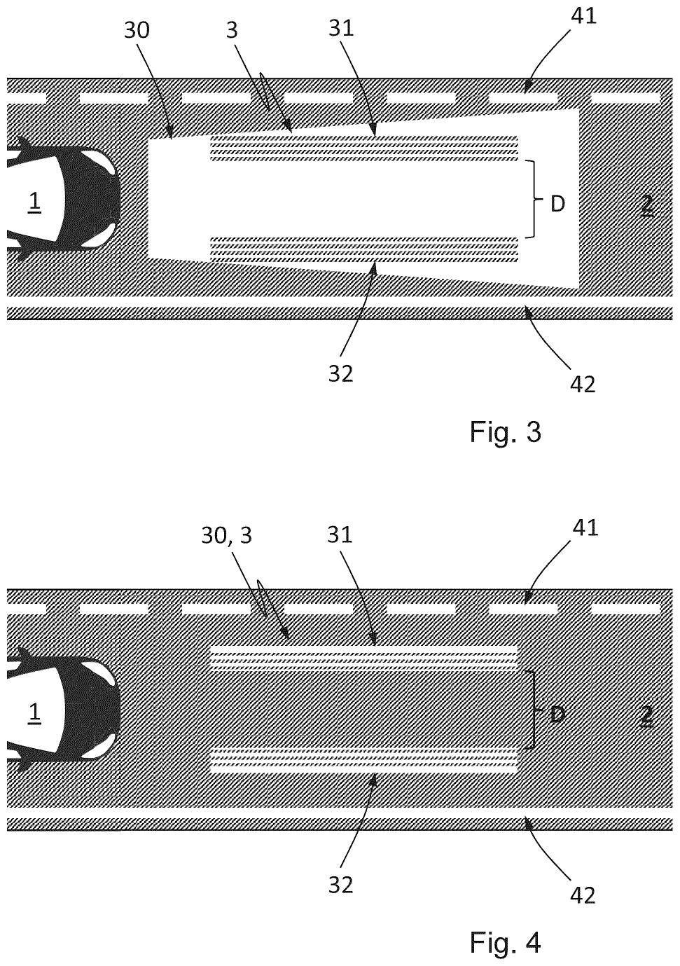

In the exemplary embodiments shown in FIGS. 2, 4, 5, and 6, the lane markings 3 are generated directly by the light distribution 30 projected onto the road surface, while in FIG. 3, the lane markings 3 are generated by the unlit sections within the light distribution 30 projected onto the road surface 2. In the latter case, the lane markings 3 are generated by targeted shading of segments within the low beam light distribution obtained with the headlamps.

In the exemplary embodiments shown in FIGS. 2-4, the individual lane markings 31, 32 contain four parallel lines, and the individual lane markings 31, 32 in the exemplary embodiment shown in FIG. 4 are of different widths. In the exemplary embodiment shown in FIG. 3, the four parallel lines forming the individual lane markings 31, 32 are not lit directly by the light distribution 30 projected onto the road surface 2 (the pattern in the illustration corresponds to the pattern in the unlit part of the road surface 2).

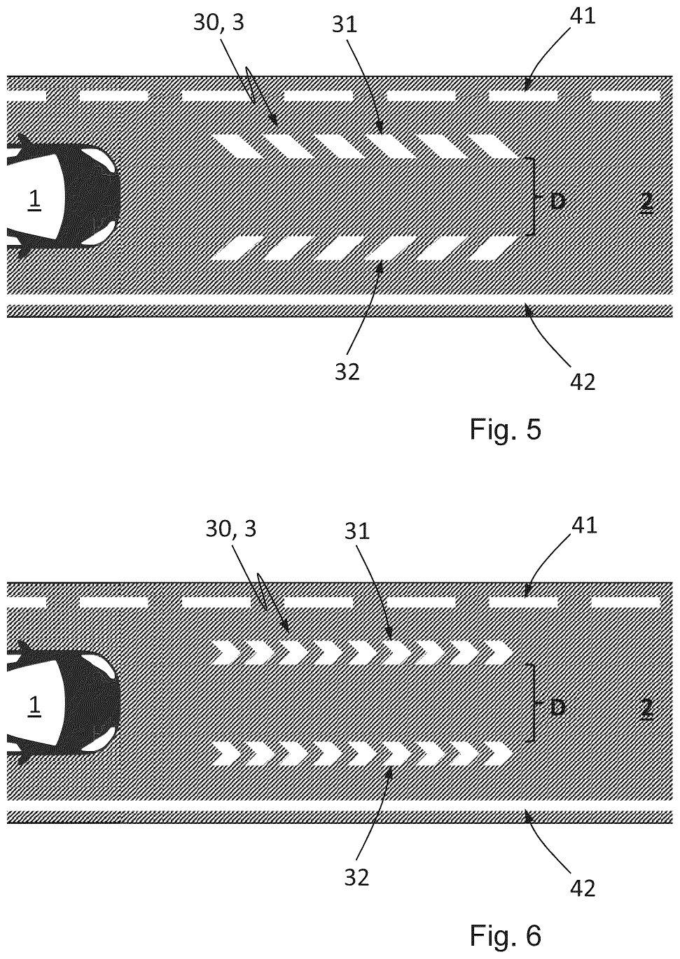

The individual markings 31, 32 in the exemplary embodiments shown in FIGS. 5 and 6 each contain a pattern of separate polygonal elements, which form a herringbone pattern in the exemplary embodiment shown in FIG. 6.

The invention is not limited to the preferred exemplary embodiments described above. Numerous variations are conceivable with which different embodiments can be used to obtain the same results. All of the features and/or advantages that can be derived from the claims, description, or drawings can be considered substantial to the invention in and of themselves or in various combinations.

### LIST OF REFERENCE SYMBOLS

1 motor vehicle
2 road surface
3; 3a lane marking (a: prior art)
30, 30a light distribution (a: prior art)
31, 32; 31a, 32a individual lane markings (a: prior art)
41 road surface lane markings (broken line)
42 road surface lane markings (solid line)
D distance between individual lane markings

1. A method for operating a light-based driver assistance system in a motor vehicle, the method comprising:
projecting a light distribution onto the road surface in front of the motor vehicle, wherein the light distribution generates lane markings, wherein the lane markings are two individual parallel lane markings at a distance (D) to one another that corresponds to the width of the motor vehicle, wherein the individual lane markings are not a solid line.

2. The method according to claim 1, wherein the individual lane markings look different than normal road surface lane markings.

3. The method according to claim 1, wherein the individual lane markings each look different than a double line, broken line, or a pair of lines composed of a solid line and a broken line.

4. The method according to claim 1, wherein the individual lane markings each contain at least three parallel lines.

5. The method according to claim 4, wherein the at least three parallel lines are of different widths.

6. The method according to claim 1, wherein the individual lane markings each contain a pattern of separate polygonal elements.

7. The method according to claim 6, wherein the individual lane markings each contain a herringbone pattern.

8. The method according to claim 1, wherein the individual lane markings each contain a pattern of freeform elements.

9. The method according to claim 1, wherein the lane markings are generated directly by the light distribution projected onto the road surface.

10. The method according to claim 1, wherein the lane markings are generated by unlit sections of the light distribution projected onto the road surface.
